(19) United States
(12) Patent Application Publication
(10) Pub. No.: US 2025/0251707 A1
(43) Pub. Date: Aug. 7, 2025

(54) Method and Electronic Assembly for an Automation System

(71) Applicant: Siemens Aktiengesellschaft, Muenchen (DE)

(72) Inventors: Valentin KORT, Landau (DE); Eberhard SCHLARB, Gundelfingen (DE)

(21) Appl. No.: 18/855,423

(22) PCT Filed: Apr. 11, 2023
(86) PCT No.: PCT/EP2023/059401

§ 371 Date: Oct. 9, 2024

(30) Foreign Application Priority Data
Apr. 12, 2022 (EP) 22167893

(51) Int. Cl. G05B 19/042

(52) U.S. Cl. CPC G05B 19/0423; G05B 2219/21013

(57) ABSTRACT

An electronic assembly and method for operating the electronic assembly for an automation system, wherein the electronic assembly includes an electronic channel or a plurality of electronic channels and at least one control unit, where an electronic channel has, in each case, a voltage input for applying an input voltage to the electronic channel, a voltage output for tapping off an output voltage at the electronic channel and a buck converter that converts the input voltage applied to the voltage input to the output voltage that has a lower absolute value, and where the method includes applying an input voltage to the voltage input of at least one electronic channel and controlling the buck converter via the control unit such that a signal in accordance with the HART standard can be tapped off at the at least one electronic channel using the output voltage.

### CROSS-REFERENCE TO RELATED APPLICATIONS

This is a U.S. national stage of application No. PCT/EP2023/059401 filed 11 Apr. 2023. Priority is claimed on European Application No. 22167893.1 filed 12 Apr. 2022, the content of which is incorporated herein by reference in its entirety.

### BACKGROUND OF THE INVENTION

### 1. Field of the Invention

The invention relates to an electronic assembly for an automation system, a control system for a technical installation, in particular a production or process installation, and relates to a method for operating the electronic assembly for the automation system.

### 2. Description of the Related Art

As the number of channels increases and due to the limited size, electronic assemblies, such as the Simatic assemblies from SIEMENS, generate a high power loss. One challenge, therefore, is to find practical measures to ensure operation at high temperatures. It is known to limit the number of active electronic channels in an electronic assembly to prevent overheating of the electronic assembly.

According to the prior art, an additional interface is also required to operate the electronic assembly in accordance with the HART standard.

DE 10 2020 124 592 A1 discloses an input/output module. The input/output module comprises a plurality of connections, where it is possible to use each connection as an input for connecting a sensor to the input/output module.

### SUMMARY OF THE INVENTION

It is an object of the invention is to provide an electronic assembly for an automation system that enables effective thermal management and low-cost operation in accordance with the HART standard at the same time.

This and other objects and advantages are achieved in accordance with the invention by an electronic assembly for an automation system, by a control system for a technical installation, in particular a production or a process installation, and by a method for operating the electronic assembly for the automation system.

An electronic assembly in accordance with the invention for an automation system has an electronic channel or a plurality of electronic channels, where the electronic assembly includes at least one control unit. Each electronic channel has:
a voltage input for applying an input voltage to the electronic channel,
a voltage output for tapping off an output voltage at the electronic channel, and
a buck converter that is configured to convert the input voltage applied to the voltage input to the output voltage that has a lower absolute value.

The control unit of the electronic assembly is configured to control the buck converter such that a signal in accordance with the HART standard can be tapped off at the respective electronic channel using the output voltage.

When the term voltage input/voltage output or input voltage/output voltage is used here, it should be understood that it is also possible for an input current to flow into the electronic channel and an output current to flow out of the electronic channel.

The functionality of the electronic assembly is preferably bidirectional. This means that the control unit, in conjunction with the buck converter, can not only provide the HART signal at the voltage output, but that the control unit can convert a HART signal received from the voltage output into digital information that can be further processed or used in the opposite direction.

In the simplest case, the electronic assembly has a single electronic channel that comprises the aforementioned components. It should be understood only a single control unit is required to provide the functionalities in accordance with the invention. In the case of several electronic channels, a single control unit, but also several control units, can be used to provide the above-mentioned functionality.

The term “a signal in accordance with the HART standard” in this case means that the signal meets the specifications of the HART standard with regard to parameters, such as voltage, current, and/or oscillation frequency.

The electronic assembly in accordance with the invention advantageously uses a buck converter that is controlled by the control unit. This makes it possible to provide a low-loss voltage at the voltage output in order, for example, to operate a sensor or measuring transducer at the voltage output. In a particularly advantageous manner, the control unit in combination with the buck converter generates a signal that can be tapped at the voltage output and that complies with the HART standard. This eliminates the need to provide a separate unit for generating the HART signal, which can reduce the complexity of the electronic assembly and improve its efficiency.

Preferably, the control unit configured to control the buck converter such that an oscillation frequency of the output voltage is in a range from 100 hertz to 3000 hertz, preferably in a range from 1000 hertz to 2500 hertz.

The amount of output voltage can be between a voltage value of 8 volts and a voltage value of 25 volts, while the amount of input voltage can be a voltage value of essentially 30 volts.

The buck converter preferably has at least one transistor, in particular a field effect transistor, where the control unit is connected to a control input of the transistor to control a switching state of the transistor for converting the input voltage.

Particularly preferably, the electronic channel or channels each have an apparatus for detecting the strength of a current through the respective electronic channel. This apparatus can measure the amount of current strength of the current flowing through the electronic channel, for example, into a sensor connected to the voltage output.

The control unit can be a Field Programmable Gate Array (FPGA) or a microcontroller. These control units are characterized by a low expenditure of operating energy and are widely available.

The objects and advantages are also achieved in accordance with the invention by a control system for a technical installation, in particular a production or process installation, comprising at least one processor unit for operating and monitoring the technical installation and an electronic assembly connected to the processor unit, which is configured as described above.

The technical installation can be a plant from the process industry, such as a chemical, pharmaceutical or petrochemical plant or a plant from the food and beverage industry. This also includes any plants from the production industry, plants in which, for example, cars or goods of all kinds are produced. Technical installations that are suitable for implementing the method in accordance with the invention may also come from the field of energy generation. Wind turbines, solar systems or power plants for energy generation are also covered by the term technical installation.

In the present context, a control system is understood to be a computer-assisted, technical system that includes functionalities for displaying, operating and controlling the process engineering installation. The control system can also include sensors for determining measured values and various actuators. In addition, the control system can comprise so-called process or production-related components that are used to control the actuators or sensors. Furthermore, the control system can have, inter alia, for a way to visualize the process engineering installation and for engineering. The control system can optionally also include further computing units for more complex controls and systems for data storage and processing.

A processor unit for operating and monitoring can be a so-called “Operator Station Server”. This is understood here to mean a server that centrally records data from an operating and monitoring system and, as a rule, alarm and measured value archives of a control system of a technical installation and makes them available to users. The Operator Station Server usually establishes a communication connection to automation systems of the technical installation and forwards data of the technical installation for visualization to operator station clients, which are used to operate and monitor the operation of the individual functional elements of the technical installation. The Operator Station Server may have client functions to access the data (archives, messages, tags, variables) of other Operator Station Servers.

As a result, images of an operation of the technical installation on the Operator Station Server can be combined with variables from other Operator Station Servers (server-server communication). The Operator Station Server can be, but is not limited to, a SIMATIC PCS 7 Industrial Workstation Server from SIEMENS.

An operator of the technical installation can access the Operator Station Server via the Operator Station Client, which can be, for example, a tablet, a smartphone, a personal computer or the like, for the purpose of operating and monitoring the technical installation.

The objects and advantages are also achieved in accordance with the invention by a method for operating an electronic assembly for an automation system, where the electronic assembly includes an electronic channel or a plurality of electronic channels, and includes at least one control unit, where each electronic channel includes:
a voltage input for applying an input voltage to the electronic channel,
a voltage output for tapping off an output voltage at the electronic channel, and
a buck converter that is configured to convert the input voltage applied to the voltage input to the output voltage that has a lower absolute value. The method comprises:
a) applying an input voltage to the voltage input of at least one electronic channel, and
b) controlling the buck converter of the at least one electronic channel via the control unit such that a signal in accordance with the HART standard can be tapped off at the at least one electronic channel using the output voltage.

As mentioned previously, the output voltage applied to the voltage output can be used to operate a measuring device for detecting a physical variable.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

The properties, features and advantages of this invention described above and the manner in which these are achieved will become clearer and more comprehensible in connection with the following description of exemplary embodiments, which are explained in more detail hereinafter with reference to the drawings, in which:

FIG. 1 is a schematic structural representation of an electronic assembly in accordance with the invention;

FIG. 2 is a graphical plot of a time profile of a voltage applied to the voltage output of an electronic channel of an electronic assembly; and

FIG. 3 is a flowchart of the method in accordance with the invention.

### DETAILED DESCRIPTION OF THE EXEMPLARY EMBODIMENTS

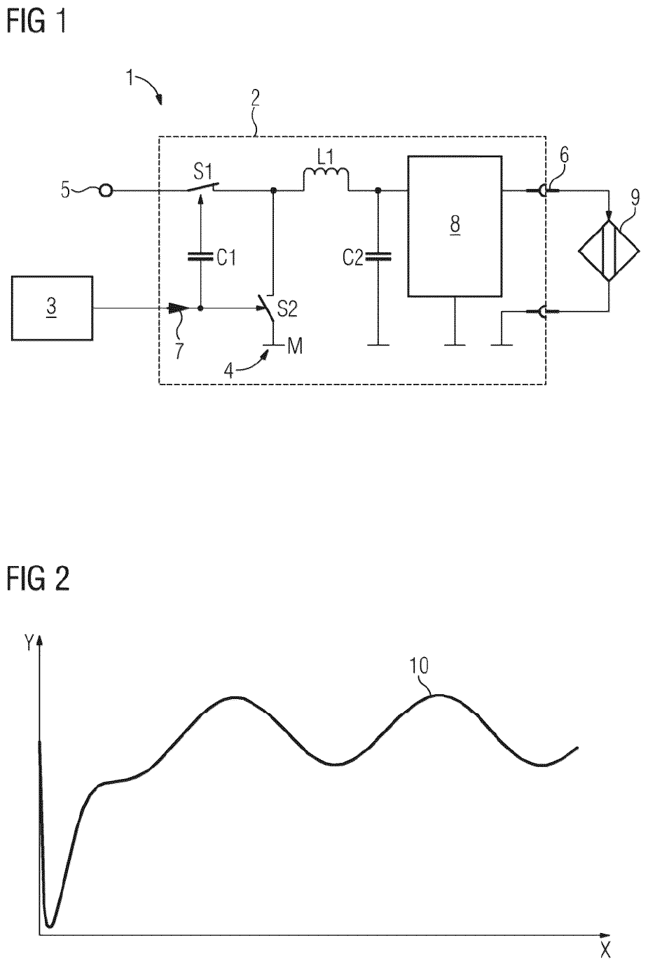

FIG. 1 shows a circuit diagram of an electronic assembly 1 in accordance with the invention. The electronic assembly 1 has a plurality of electronic channels 2, of which a single electronic channel 2 is shown as an example. The electronic assembly 1 has a control unit 3, a buck converter 4, a voltage input 5 and a voltage output 6.

The buck converter 4 has a first transistor S1, a second transistor S2, a first capacitance C1, a second capacitance C2 and an inductance L1. The control unit 3 is connected to a control input of the first transistor S1 via the first capacitance C1. In addition, the control unit 3 is directly connected to a control input of the second transistor S2.

The control unit 3 is formed as a Field Programmable Gate Array (FPGA) and controls the two transistors S1, S2 via a pulse-width modulated signal 7. This signal 7 places either the first transistor S1 or the second transistor S2 in a conductive state, so that the voltage input 5 is either connected to or disconnected from the inductance L1. When the second transistor S2 is in a conductive state, the inductance L1 is connected to a ground M.

The buck converter 4 converts an input voltage applied to the voltage input 5 which, for example, has a voltage value of 30 volts, into a smaller output voltage (for example, in a range from 8 volts to 25 volts), which is provided at the voltage output 6. The control unit 3 is configured to control the buck converter 4 (due to the characteristic of the pulse-width modulated signal) such that a signal in accordance with the HART standard can be tapped at the voltage output 6. In this regard, reference should be made to the embodiments with reference to FIG. 2.

The electronic channel 2 also has an apparatus 8 for detecting the strength of a current through the electronic channel 2. The voltage output 6 of the electronic channel 2 is connected to a measuring transducer 9, which is used to detect a physical measured variable. The control unit 3 is configured to convert signals generated by the measuring transducer 9 in accordance with the HART standard into digital data for further use.

FIG. 2 shows the output voltage 10 (Y-axis in volts) measured at the voltage output 6 of the electronic channel 2 in a time profile (X-axis in milliseconds). After a transient range 11, the output voltage has a voltage value that oscillates approximately between 13 volts and 14 volts. An oscillation frequency is approximately 2, 200 hertz. This corresponds to a logical zero in accordance with the HART standard. A logical one would be transmitted at a frequency of 1, 200 hertz. The output voltage 10 can be summarized as a signal in accordance with the HART standard.

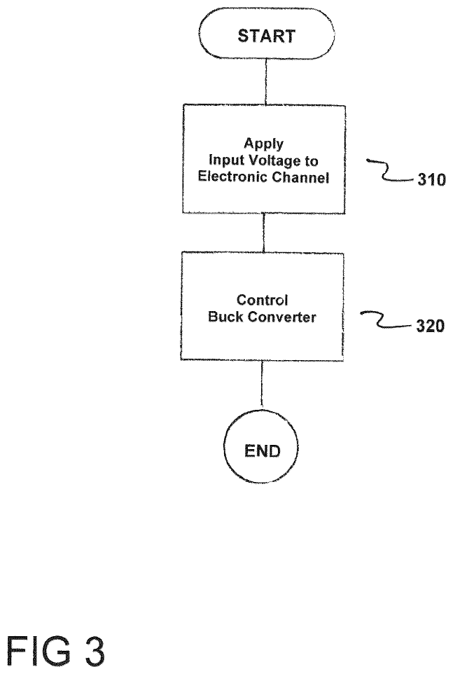

FIG. 3 is a flowchart of the method for operating an electronic assembly 1 for an automation system, where the electronic assembly 1 includes an electronic channel 2 or a plurality of electronic channels 2, at least one control unit 3, and where an electronic channel 2 or each electronic channel 2 of the plurality of electronic channels comprises a voltage input 5 for applying an input voltage to the electronic channel 2, a voltage output 6 for tapping off an output voltage at the electronic channel 2 and a buck converter 4 that is configured to convert the input voltage applied to the voltage input 5 to the output voltage which has a lower absolute value. The method comprises a) applying an input voltage to the voltage input 5 of at least one electronic channel 2, as indicated in step 310.

Next, b) the buck converter 4 of the at least one electronic channel 2 is controlled via the control unit 3 such that a signal in accordance with a HART standard, which is valid that the time of filing the instant application, can be tapped off at the at least one electronic channel 2 via the output voltage, as indicated in step 320.

Although the invention has been illustrated and described in more detail by the preferred exemplary embodiment, the invention is not limited by the disclosed examples and other variations may be derived therefrom by a person skilled in the art without departing from the scope of the invention.

Thus, while there have been shown, described and pointed out fundamental novel features of the invention as applied to a preferred embodiment thereof, it will be understood that various omissions and substitutions and changes in the form and details of the methods described and the devices illustrated, and in their operation, may be made by those skilled in the art without departing from the spirit of the invention. For example, it is expressly intended that all combinations of those elements and/or method steps that perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

1.-10. (canceled)

11. An electronic assembly for an automation system, the electronic assembly comprising:
an electronic channel or a plurality of electronic channels; and
at least one control unit, an electronic channel or each electronic channel of the plurality of electronic channels comprising:
a voltage input for applying an input voltage to the electronic channel;
a voltage output for tapping off an output voltage at the electronic channel; and
a buck converter which is configured to convert the input voltage applied to the voltage input to the output voltage which has a lower absolute value;
wherein the at least one control unit is configured to control the buck converter such that a signal in accordance with a HART standard can be tapped off at a respective electronic channel via the output voltage.

12. The electronic assembly as claimed in claim 11, wherein the at least one control unit is configured to control the buck converter such that an oscillation frequency of the output voltage is in a range from 100 hertz to 3000 hertz;

13. The electronic assembly as claimed in claim 11, wherein the oscillation frequency of the output voltage is in a range from 1000 hertz to 2500 hertz.

14. The electronic assembly as claimed in claim 12, wherein the output voltage has a value of between 8 volts and 25 volts.

15. The electronic assembly as claimed in claim 11, wherein the output voltage has a value of between 8 volts and 25 volts.

16. The electronic assembly as claimed in claim 11, wherein the input voltage has a value of essentially 30 volts.

17. The electronic assembly as claimed in claim 11, wherein the buck converter has at least one transistor; and wherein the control unit is connected to a control input of the at least one transistor to control a switching state of the at least one transistor for converting the input voltage.

18. The electronic assembly as claimed in claim 17, wherein the at least one transistor is a field effect transistor.

19. The electronic assembly as claimed in claim 11, wherein the electronic channel or the plurality of electronic channels each have an apparatus for detecting a value of a current through a respective electronic channel.

20. The electronic assembly as claimed in claim 11, wherein the control unit is a Field Programmable Gate Array or a microcontroller.

21. A control system for a technical installation, comprising at least one processor unit for operating and monitoring the technical installation and an electronic assembly connected to a computer unit as claimed in claim 11.

22. The control system for a technical installation as claimed in claim 21, wherein the technical system comprises a production or process installation.

23. A method for operating an electronic assembly for an automation system, the electronic assembly including an electronic channel or a plurality of electronic channels, at least one control unit, and an electronic channel or each electronic channel of the plurality of electronic channels comprising a voltage input for applying an input voltage to the electronic channel, a voltage output for tapping off an output voltage at the electronic channel and a buck converter which is configured to convert the input voltage applied to the voltage input to the output voltage which has a lower absolute value, the method comprising:
a) applying an input voltage to the voltage input of at least one electronic channel;
b) controlling the buck converter of the at least one electronic channel via the control unit such that a signal in accordance with a HART standard can be tapped off at the at least one electronic channel via the output voltage.

24. The method as claimed in claim 23, wherein the output voltage applied to the voltage output is utilized to operate a measuring device for detecting a physical variable.
